(19) United States
(12) Patent Application Publication
(10) Pub. No.: US 2024/0104138 A1
(43) Pub. Date: Mar. 28, 2024

(54) APPARATUS, METHOD, AND SYSTEM

(71) Applicant: Intel Corporation, Santa Clara, CA (US)

(72) Inventor: Robert VAUGHN, Portland, OR (US)

(21) Appl. No.: 18/534,795

(22) Filed: Dec. 11, 2023

(51) Int. Cl. G06F 16/901

(52) U.S. Cl. CPC G06F 16/9024

(57) ABSTRACT

It is provided an apparatus comprising interface circuitry, machine-readable instructions, and processing circuitry to execute the machine-readable instructions. The machine-readable instructions comprise instructions to obtain a first hash value of a first data record which is part of a first sequence of chained data records. The machine-readable instructions comprise instructions to obtain a second hash value of a second data record which is part of a second sequence of chained data records. The machine-readable instructions comprise instructions to generate a new data record comprising a hash value which is based on the first hash value of the first sequence of chained data records and on the second hash value of the second sequence of chained data records. The machine-readable instructions comprise instructions to add the new data record to the first sequence. The new data record following the first data record in the first sequence.

### BACKGROUND

In digital communication and data processing it is important to ensure that stored and shared data remains accurate and unaltered from its original state, that is to ensure data integrity. Provable immutability, the guarantee that data has not been tampered with, becomes challenging in environments where information is shared or relied upon by multiple parties. For instance, in supply chain management, financial services, or healthcare records, where the integrity of data can have significant real-world consequences, any breach or unauthorized alteration can lead to mistrust, legal issues, and financial loss. The complexity may be heightened when data crosses organizational boundaries, requiring stringent measures to verify and maintain its integrity across different systems and stakeholders.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus or device;

FIG. 2 illustrates a sequence of chained data records;

FIG. 3 illustrates a data integrity network, which comprise four sequences of chained data records;

FIG. 4 illustrates an example of a data record;

FIG. 5 illustrates a hash binding of data records in a sequence of chained data records;

FIG. 6 illustrates an integrity network comprising eight nodes generating sequences of chained data records;

FIG. 7 illustrates a system comprising a plurality of nodes; and

FIG. 8 illustrates a flowchart of an example of a method.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

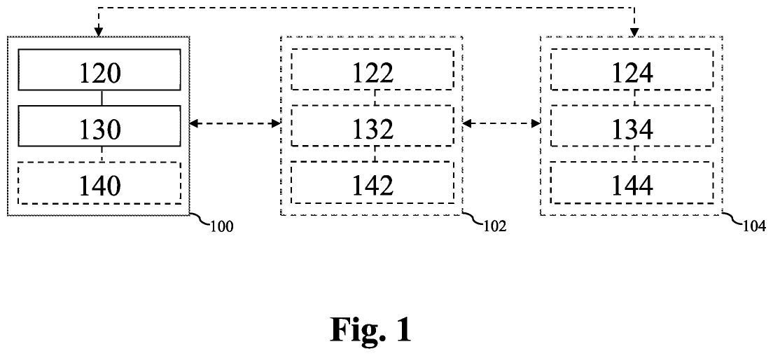

FIG. 1 illustrates a block diagram of an example of an apparatus 100 or device 100. The apparatus 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140 (for storing information, such as machine-readable instructions).

Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

The processing circuitry 130 is configured to obtain a first hash value of a first data record. The first data record is part of a first sequence of chained data records. Further, the processing circuitry 130 is configured to obtain a second hash value of a second data record. The second data record is part of a second sequence of chained data records.

In one example the first sequence and also the second sequence may be generated by the processing circuitry 130 (for example the apparatus 100 is operating a first node, generating the first sequence, and also operating the second node, generating the second sequence). In this case the apparatus 100/processing circuitry 130 may obtain the first sequence and the second sequence for example via internal communication means from the interface circuitry 120 and/or the storage circuitry 140 or the like.

In another example the apparatus 100 may be communicatively coupled to a second apparatus 102. The second apparatus may comprise interface circuitry 122, processing circuitry 132 and (optional) storage circuitry 142. The components of the second apparatus 102 may be implemented similar as the components of the apparatus 100. For example, the second interface circuitry 122 of the second apparatus 102 may be communicatively coupled to the interface circuitry 120 of the first apparatus 100. In this case, for example, the first sequence may be generated by processing circuitry 130 of the apparatus 100 (for example the apparatus 100 is operating a first node, generating the first sequence). Further, the second sequence may be generated by the second processing circuitry 132 (for example the second apparatus 102 is operating aa second node, generating the second sequence). For example, the apparatus 100/processing circuitry 130 may obtain the first sequence for example via internal communication from the interface circuitry 120 or the storage circuitry 140 or the like. Further, the apparatus 100/processing circuitry 130 may obtain the second sequence for example via the interface circuitry 120 from the second apparatus 102.

In another example the apparatus 100 may be communicatively coupled to the second apparatus 102 and to a third apparatus 104. The third apparatus may comprise interface circuitry 124, processing circuitry 134 and (optional) storage circuitry 144. The components of the third apparatus 104 may be implemented as the components of the apparatus 100. For example, the interface circuitry 120 may be communicatively coupled to the second interface circuitry 122 of the second apparatus 102 and to the interface circuitry 124 of the third apparatus. The second interface circuitry 122 may be communicatively coupled to the third interface circuitry 124 of the third apparatus 104. In this case, for example, the first sequence may be generated by second processing circuitry 132 of the second apparatus 102 (for example the second apparatus 102 is operating a first node, generating the first sequence). Further, the second sequence may be generated by the third processing circuitry 134 (for example the third apparatus 104 is operating a second node, generating the second sequence). For example, the apparatus 100/processing circuitry 130 may obtain the first sequence for example via the interface circuitry 120 from the second apparatus 102. Further, the apparatus 100/processing circuitry 130 may obtain the second sequence for example via the interface circuitry 120 from the third apparatus 104. In yet another example, the second apparatus 102 may generate the first and the second sequence and the apparatus 100/processing circuitry 130 may obtain the first and the second sequence via the interface circuitry 120 from the second apparatus 102.

For example, a hash value and/or data record (for example the first data record or the second data record) may be obtained via an application programming interface (API). An API may be used for internal communication, for example internal communication inside the apparatus 100, or for communication between different apparatuses.

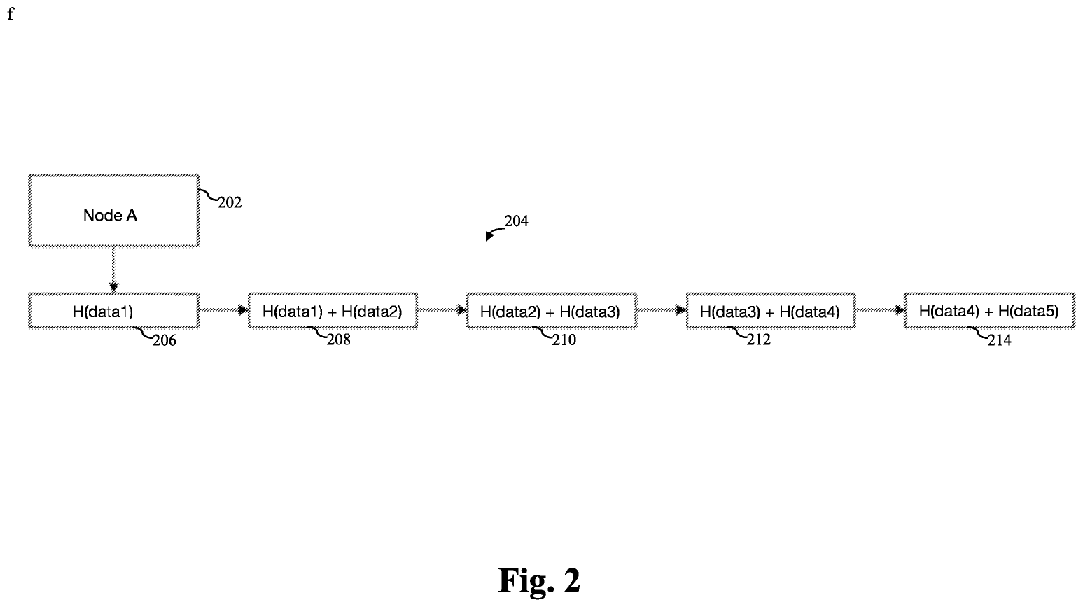

A sequence of chained data records (also referred to as transactions or as data points)—for example the first or the second sequence of chained data records—may be an ordered set of data records. Each data record in the sequence of chained data records is chained to a preceding data record. Two chained data records are chained together by a hash value generated by a hash function (for example, a cryptographic hash function). This chaining of two data records is also referred to as hash-binding. That is a hash function may be applied to a current data record in the sequence to generate a hash value. Said generated hash value may then be used as an input (for example among other inputs) for the hash function applied to the following data record. In other words, in the first sequence of chained data records and in the second sequence of chained data records a respective following data record is chained to a respective preceding data record based on the following data record comprising a hash value of the preceding data record. The of chaining of data records/hash binding of data records is also shown in FIG. 2.

A hash function may a mathematical algorithm that transforms an input of any length into a fixed-size string of characters, referred to as the hash value. Its purpose may be to map data of arbitrary size to data of fixed size, facilitating tasks like data retrieval in hash tables by ensuring uniform distribution of hash values.

For example, a hash value (for example least one of the first hash value, the second hash value, the third hash value or the hash value of the new data record) may be generated using a cryptographic hash function. A cryptographic hash function is a special case of hash functions, designed with security features for use in cryptography. A cryptographic hash function is computationally infeasible to reverse, making it difficult to deduce the original input given the hash value. It also ensures that even a small change in the input may result in a substantially different hash value, exhibiting the avalanche effect, and is resistant to collisions, making it unlikely to find two different inputs that produce the same hash value.

For example, the first hash value may be based on a hash value of a data record in the first sequence of chained data records preceding the first data record. For example, the first hash value may be generated by a hash function which receives as an input (probably among other inputs) the hash value of the data record in the first sequence of chained data records preceding the first data record. Further, the second hash value may be based on a hash value of a data record in the second sequence of chained data records preceding the second data record. Accordingly, the second hash value may be generated by a hash function which receives as an input (probably among other inputs) the hash value of the data record in the second sequence of chained data records preceding the second data record.

For example, a (e.g., cryptographic) hash function H(x) receives an input x and generates as an output a hash value y, y=H(x). Given the first/second sequence of chained data records S with a current data record S[i], a hash binding operation (the chaining of the data records) may be represented as:

S[i+1]=H(S[i]) (Equation 1)

Equation (1) indicates that the following data record S[i+1] (or parts of that data record) in the first/second sequence of chained data records S, is obtained by applying the hash function H(S[i]) to the current data point S[i].

FIG. 2 illustrates a sequence of chained data records 204. A node A 202 generates a sequence of chained data records 204. For example, the node A 202 is implemented by the apparatus 100/processing circuitry 130. The first data record 206 in the sequence of chained data records 204 comprises (probably among other data) a first hash value H(data1) of the first data data1. A second data record 208 in the sequence of chained data records 204 comprises the first hash value H(data1) of the first data data1 and also a second hash value H(data2) of the second data data2. The second data data2 may comprise the first hash value H(data1) of the first data data1. Therefore, the second hash value H(data2) of the second data data2 may be based on the first hash value H(data1) of the first data data1, because the hash function H received first hash value H(data1) as an input. A third data record 210 in the sequence of chained data records 204 comprises the second hash value H(data2) of the second data data2 and also a third hash value H(data3) of the third data data3. The third data data3 may comprise the second hash value H(data2) of the second data data2, and therefore the third hash value H(data3) of the third data data3 may be based on the second hash value H(data2) of the second data data2. A fourth data record 212 in the sequence of chained data records 204 comprises the third hash value H(data3) of the third data data3 and also a fourth hash value H(data4) of the fourth data data4. The fourth data data4 may comprise the third hash value H(data3) of the third data data3, and therefore the fourth hash value H(data4) of the fourth data data4 may be based on the third hash value H(data3) of the third data data3.

Further, the processing circuitry 130 is configured to generate a new data record comprising a hash value. The generated hash value is based on the first hash value of the first sequence of chained data records and on the second hash value of the second sequence of chained of data records. Further, the processing circuitry 130 is configured to add the new data record to the first sequence of chained data records. The new data record is following the first data record in the first sequence.

For example, the new data record may be added into the first sequence of chained data records subsequent the first data record. That is, the new data record may be preceding the new data record in the first sequence of chained data records. For example, the new record may be added into the first sequence directly after the first data record or it may be added into the first sequence at the next but one place after the first record or at any later other point in the first sequence.

For example, the generated hash value in the new data record is generated by the hash function. The hash function may receive as input (for example among other inputs) the first hash value of the first sequence of chained data records and the second hash value of the second sequence of chained of data records. Thereby, the generated hash value in the new data record is chained (hash bound) the preceding data record in the first sequence and to the data record in the second sequence.

Further, the processing circuitry 130 may be configured to obtain a third hash value of a third data record. The third data record may be part of a third sequence of chained data records. The third hash value may be based on a hash value of a data record in the third sequence of chained data records preceding the third data record. Further, the processing circuitry 130 may add the new data record to the first sequence of chained data records. The new data record may comprise the hash value. The hash value may be further based on the third hash value of the third sequence of chained data records.

Furthermore, according to equation (1) the chaining (hash binding) of a first sequence of chained data records R and second sequence of chained data records S may be described by a formula. For example, the first sequence R (or the node generating the second sequence) is requesting and receiving the data record S[j] (the j-th data record in the second sequence S. A hash binding operation (the chaining of the data records) may be represented as:

R[i+1]=H(S[j]) (Equation 2)

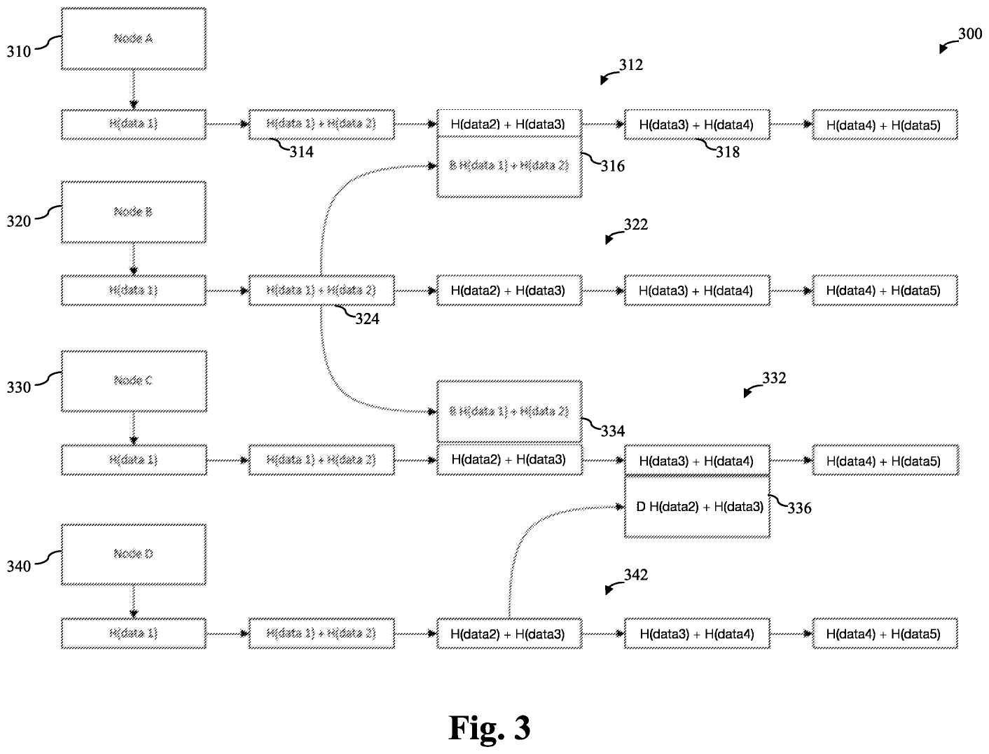

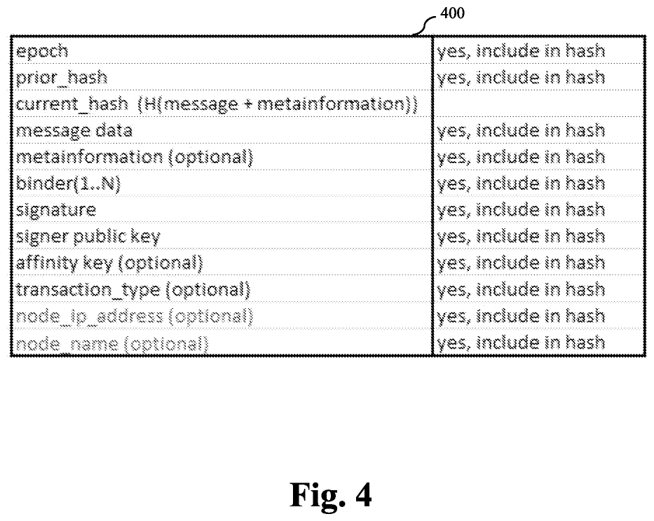

R[i+1] represents the (i+1)-th data record in the first sequence R. Equation (2) indicates that data record R [i+1] (or parts of that data record) in the first sequence of chained data records R, is obtained by applying the hash function H(S[i]) to the data point S[j] of the second sequence S. Thereby, data records from the second sequence are hash bound (chained) to the first sequence. This is also illustrated in FIGS. 3 and 4.

The above described technique increases the security and integrity of a sequence of chained data records when the data records of the second sequence are chained to the first sequence as described above. That is the two (or more) sequences are interconnected into tangle chains which increases the integrity make the sequences tamper proof.

The sequences of chained data records may subsequently be verified by third interested parties that are interested in the integrity of the data. Two or more sequences of chained data records that are (partly) hash-bound among each other, are also referred to as a data integrity network. The data integrity network may user discretionary interconnects and user originated chain tangles.

Further, the processing circuitry 130 may be configured to run a first node. The first node may be configured to generate the first sequence of chained data records. Further, the processing circuitry 130 may be configured to retrieve, by the first node, the second hash value of the second data record from a second node. In other words, the processing circuitry 130 running the first node is configured to retrieve the second hash value of the second data record from a second node. The second node is configured to generate the second sequence of chained data records.

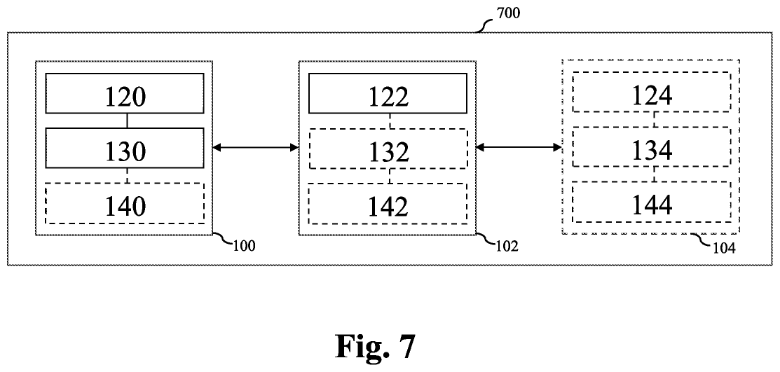

A node (e.g., a first node, a second node, a third node) may refer to an active, connective entity within a computer network or a distributed system (see also FIG. 7). For example, a node may be implemented as a physical device, such as apparatus 100/102/104 or as a virtual instance such as a virtual machine or the like. To run a node may refer to ensuring that said entity is engaged in its tasks within the network. For example, the processing circuitry 130/132/134 of the apparatus 100/102/104 may run the respective node. In some examples, a node may be run (operated) by a specific organization such as a company or a university or government agency or the like. A node may publicly publish data records or push to an API/retrieve from an API. Other participants, through their own nodes, may upon either frequency (i.e., quantity) or epoch bind a data record on the first user's sequence chain.

For example, a first and a second node respectively generate a first and a second sequence. At a given time or after a certain number of data records, for example the first sequence (or the node generating the first sequence) may request data record(s) from the second sequence in the network. The received data records from the second sequence is then hash-bound to the first requesting sequence, creating a tangle, comingle, or interlink between two or more interlinking sequences.

For example, the first node may be implemented by the apparatus 100 and for example the processing circuitry 130 may be configured to run the first node. Further, for example, the second node may be implemented by the second apparatus 102 and for example the second processing circuitry 132 may configured to run the second node. In another example, one or both of the first and second node are implemented as virtual nodes, for example run by the processing circuitry 130. The first node and the second node may respectively be configured to generate the first and the second sequence of chained data records as described above. For example, the processing circuitry 130 running the first node may request the second hash value of the second data record from the second node. When receiving the second hash value from the second node, the processing circuitry 130 may generate the hash value of the new data record as described above.

In another example, the processing circuitry 130 is configured to run a first node. The first node is configured to generate the first sequence of chained data records. Further, the processing circuitry 130 is configured to transmit, by the first node, the first hash value of the first record or the generated hash value of the new data record to a third node. In other words, the processing circuitry 130 running the first node is configured to transmit the first hash value or the generated hash value to a third node. The third node is configured to generate a fourth sequence of chained data records.

For example, the first node may be implemented by the apparatus 100 and the processing circuitry 130 may be configured to run the first node. Accordingly, for example, the second node may be implemented by the second apparatus 102 and the second processing circuitry 132 may be configured to run the second node. For example, the third node may be implemented by the third apparatus 104 and the third processing circuitry 134 may be configured to run the third node. In another example, one or two or all of the first, second and third node are implemented as virtual nodes, for example run by the processing circuitry 130. The first, second and third node may respectively be configured to generate the first, second and third sequence of chained data records as described above. For example, the processing circuitry 130 running the first node may transmit the first hash value of the first data record or the generated hash value of the new data record to the third node. When receiving the first hash value or the generated hash value from the first node, the third node (for example the processing circuitry 134) may generate the fourth data record comprising a fourth hash value. Similar as described above, the fourth hash value may be based on preceding hash value from the fourth sequence of chained data records and on the generated hash value from the new record of the first sequence of chained data records. Therefore, the first and the second sequence of chained data records may be hash-bound to the fourth sequence of chained records.

For example, one data record may be transmitted/retrieved at a time, or a plurality of data records may be transmitted/retrieved together. It is only through the hash bindings that the connection between two or more sequences is described. There is no necessity to include information in the data records themselves that describe who is running the node that generates the respective sequence. A sequence of chained data records may not be publicly available and therefore not intended for anyone in a public sense to find the sequence. The operator who runs the node that generates a sequence decides at his own discretion who may receive and see the sequence (therefore the technique as described above may be referred to as discretionary interconnects in a chained tangle network). In contrast to that, blockchains like Ethereum or Bitcoin or the like may provide data integrity but no privacy. The technique as described above provides high data integrity and high privacy.

For example, a node may leverage client software (with an API) to ingest a data record into a sequence. A hash of that data may be derived and shared via peer to peer using a modified (simplified) peer to peer protocol similar to Gossip or Floodfill. Peers may bind then their own hash sequences. Information may then subsequently be verified by interested parties.

When a node cross-binds from a remote sequence to its own sequence of chained data records then this may create a new data record, which is (co-binding) information from the remote data record. For example, trust requirements of any particular party (running a node) may determine whether data records generated by a node will be co-bounded or not. By linking data records of different sequences together an integrity network, that is a network effect of reinforced data integrity, may be established. The network effect may be a result of the level of complexity and effort required to regenerate the network. Further, to regenerate the integrity network of comingled hash-bound data records would require the cooperation of many parties (operating nodes). Therefore, to manipulate any data record committed to the integrity network as described above, would be an activity of great cost and complexity with significant risk of discovery.

For example, data record views (or access or reads) of sequences may presuppose that a third party may have an approved reason for the viewing the data. Therefore, the operator who runs a node may communicates to a third party about a sequence that it generated and where to find it.

The above described technique provides an immediate commitment. If a node (run by a processing circuitry) receives a data record from another node, the data record is simply committed. From that point on the data record is verifiable. That is the data integrity network is able to establish provable data integrity nearly instantaneously. Therefore, compared to previous techniques the above disclosed technique does not require any consensus methods (like proof of work, proof of stake or the like) or any voting or cryptocurrency or the like.

Further, with the above described technique, compared to networks comprising chains of data records, like a blockchain (i.e., a ledger, a linear binding of blocks) no forks occur. That is because the data records are committed immediately, there is no voting or consensus and therefore no forking. Instead, the technique as described above provides a data integrity protocol.

Further, the above described technique is anonymous, compared to pseudo-anonymity provided by blockchains or the like. The data records do not necessarily need to comprise addresses. However, a party that has, through other channels, been made aware of a sequence of chained data records may determine the trust status of the sequence.

Further, the above described technique is “self-policing” in that the control stays with the operator running a node and data record design prevents harmful data.

Further, the above described technique is decentralized, and no central authority is needed to organize the network.

In order to establish data integrity to a third party other than a data manager previous techniques required that the third party relies on the reputation of a first sharing party, or a specific vendor attest to the data's integrity or a blockchain solution. The technique as described above does not rely upon one's reputation nor an attestation vendor nor a blockchain. A first company may share data to a second company who then may share the data with a third company and so, in a manner such that each company involved in the chain of inspection can rely on the data being free from manipulation without a vendor attestation service or public blockchain.

Next, an application example is described: A first company generates a data record (i.e., a transaction) in a first sequence. Message data in that data record is encrypted, for example via Advanced Encryption Standard (AES) using a key (as in symmetric encryption). The first company wants a second company to be aware of the first sequence of chained data records. Therefore, the first company communicates (for example via email, or API, or web page or the like) to the second company where (i.e., a node which has an index of the sequence that it is storing) to find the first sequence. The second company then requests the first sequence from the node, retrieves it, and parses each data record (transaction). The second company can then use the AES key provided by other channels (for example via email) to decrypt the message data. Unless the message data is short, the decrypted message data may point to a data storage location (for example accessible via, for example, HTTPS or the like).

FIG. 3 illustrates a data integrity network 300 which comprise four sequences of chained data records. A node A 310 generates a first sequence of chained data records 312. A data record 314 in the first sequence of chained data records 314 comprises the first hash value H(data1) of the first data data1 and also a second hash value H(data2) of the second data data2. The second data data2 may comprise the first hash value H(data1) of the first data data1. Therefore, the second hash value H(data2) of the second data data2 may be based on the first hash value H(data1) of the first data data1, because the hash function H received the first hash value H(data1) as an input. The same holds true for the second sequence of chained data records 320, which comprises a data record 324, which comprises a first hash value H(data1) of the first data data1 and also a second hash value H(data2) of the second data data2 of the second sequence of chained data records. For example, node A 310 requests data record 324 from node B 320 in order to hash-bind the second sequence 322 to the first sequence 312. Node A 310 generates a data record that comprises the second hash value H(data2) of the second data data2 of the first sequence and further comprises the second hash value H(data2) of the second data data2 of the second sequence and optionally the first hash value H(data1) of the first data data1 of the second sequence (which may already be implicitly included in the second hash value H(data2) of the second data data2 of the second sequence). Further, the third data record 316 of the first sequence comprises a third hash value H(data3) of the third data data3 of the first sequence. The third data data3 of the third sequence may comprise the hash value H(data2) of the first sequence and H(data1) and H(data2) of the second sequence. Therefore, when generating the third hash value H(data3) of the third data data3 of the first sequence the hash function may have received the second hash value H(data2) of the second data data2 of the first sequence and the second hash value H(data2) of the second sequence and optionally the first hash value H(data1) of the second sequence (which may already be implicitly included in the second hash value H(data2) of the second data data2 of the second sequence) as an input. Thereby, the first sequence 312 and the second sequence 322 are chained together (hash-bound). The same binding is performed in the second data record 334 of the third sequence 332, where the second sequence 322 is chained to the third sequence 332. Further, a binding is performed in the third data record 336 of the third sequence 332, where the fourth sequence 342 is chained to the third sequence 332. For example, each of node A 310, node B 320, node C 330, node D 340 may be implemented by apparatus 100/processing circuitry 130, apparatus 102/processing circuitry 132, or apparatus 104/processing circuitry 134 and they may communicate with each other through as described above.

Difference to Previous Techniques Like Hashgraph and Directed Acyclic Graph

The above and below described technique differs in several aspects from techniques such as directed acyclic graph (DAG) or Hashgraph. A DAG is a data structure that represents an underlying architecture of certain decentralized networks, particularly those that aim to overcome some of the limitations of traditional blockchain systems. An example of a DAG-based blockchain protocol may be the soc called Tangle, which is used by the IOTA cryptocurrency. In the Tangle, each new transaction must approve and verify two previous transactions. Consequently, every transaction becomes a part of the validation process for subsequent transactions, ensuring a decentralized consensus mechanism.

Hashgraph may be described as an improvement upon DAG used by IOTA. However, it is still a consensus protocol. Both Hashgraph and Tangle (specifically, the IOTA Tangle) have a concept similar to a message pool or transaction pool. In Hashgraph, a node maintains a data structure called the “event graph”, which consists of a record of all the events (transactions, data records) that have occurred in the network. When a node receives a new event, it adds it to its local event graph and gossips the information to other nodes in the network. Before an event becomes part of the consensus order, it resides in the event graph and can be considered as being in a “message pool” or “transaction pool” state. Nodes continuously exchange information and propagate events through the gossip protocol, ensuring that events are disseminated throughout the network.

Similarly, in the IOTA Tangle, transactions are broadcasted to other nodes in the network and temporarily reside in a “transaction pool” or “message pool”. These pools store pending transactions that have been received by nodes but have not yet been confirmed and added to the Tangle. The transactions in the pool are waiting to be validated, approved, and referenced by subsequent transactions before becoming part of the Tangle. Nodes continuously perform the validation process and attach new transactions to the Tangle, updating the status of transactions in the pool accordingly.

A purpose of having a message pool or transaction pool in both Hashgraph and Tangle may be to temporarily store incoming transactions or events before they are confirmed, validated, and integrated into the main structure of the respective protocols. This pool allows for the dissemination of transactions across the network and provides a mechanism for nodes to process and validate incoming messages in an orderly manner.

In the technique as described above and below, the originating node commits a transaction the moment it is shared via peer to peer (P2P). Therefore, there may be no approval needed and no verification process before the transaction (data record) is accepted by a receiving node. If the transaction is not part of an existing sequence of chained data records, then it may be a start of a new sequence of chained data records. Further, the technique as described above and below needs no consensus or voting model, and therefore no message pool. Further, transactions may be committed immediately, without voting or consensus, and because the “ledger” may be referred to as non-linear, there is no forking. This may be important because forking may introduce disparate truths in a truth network.

Furthermore, vendor based techniques used to attest to the integrity of data lack interoperability and operate in a vendor lock-in manner. Public blockchain techniques are slow, expensive and complicated, wherein private blockchain techniques lack universal trust due to narrow scope of trust.

Elements of a Data Record

Further, beside a hash value, a data record (also referred to as transactions or data points) may comprise further information. For example, a data record (for example, the first data record, the second data record, the third data record and/or new data record) may comprise at least one of the following elements: An epoch identifier, message data, a hash value of the message data, encrypted message data, metainformation, a hash value of the metainformation, an affinity key, a signature, a signer public key, a transaction type, a node IP address, a node name.

As described above the processing circuitry 130 may generate the new data record (or any other data record as described above) comprising the hash value, wherein the hash value is based on the first hash value of the first sequence of chained data records and on the second hash value of the second sequence of chained data records. The second hash value of the second sequence of chained data records is also referred to as binder since it binds the second sequence to the first sequence. A data record may have a “home” sequence, that is the sequence of data records that is generated by its own node, for example the home sequence of the first data record is the first sequence. However, through the second hash, a reference to the second sequence is established.

Further, the generated hash value may be based on other information. That is the hash function which is generating the hash value receives further information as input. For example, generated hash value is further based on at least one of the following: An epoch identifier, message data, a hash value of the message data, encrypted message data, metainformation, a hash value of the metainformation, an affinity key, a signature, a signer public key, a transaction type, a node IP address, a node name.

An epoch may identify the number of a data records in a sequence of chained data records, for example starting with epoch 1 for the first data record in a sequence. That is the epoch may display the length of sequence of chained data records.

Message data may be any information that should be transmitted. For example, message data may be a string of information or a hash of that string of information itself. Further, the message data may be encrypted using symmetric or asymmetric methods. For example, keys or passwords are not transported via the data records (that is outside of the integrity network for example via email or the like).

Metainformation may be information with regards to the message data. For example, the metainformation may be a string of information further describing the message data, such as an URL corresponding to the message data or a hash of the meta information itself.

Further, the metainformation may comprise a hash value or the metainformation may comprise a reference to a storage location of data associated to the data record. For example, the message data may be hashed to provide for confidentiality. The metainformation may then be a URL or the like, that points to an off-chain location of the message data. For example, the data integrity system may be intended to work with an external system, and only stores hashes and messages and may not store actual user data. The system that stores the actual data would be protected in a conventional manner with an access control system (i.e., login, password, or rights). Furthermore, the metainformation may indicate a data type of the message data, like string or integer or the like. The operator who is running a node the generates a sequence may also operator the storage location (“backend”) system to provide a correlation to actual source data. There is no intermediary needed, like a blockchain mining organization operating the network or consensus process or the like, just trusted data records tied back to the originating operator through (e.g., domain) binding.

An affinity key may be a symmetric key (or a hash thereof) that may be known to predetermined parties that may be allowed to request a hash from the node and the node itself. That is an affinity key may be regard as a configuration file with regards to a node that generated the data record comprising the affinity key, which signifies to the public, whether queries from another node to transmit the data record or hash value will be answered without the according affinity key. Thereby, an affinity key may serve the purpose of registering a data record in a sequence that declares that the generating node will respond to queries from other nodes related to a defined nodes (for example a specific company or other reference) and thereby both reducing traffic to a node and protecting the privacy intended by the creator of the data record.

For example, as a network comprising a plurality of nodes generating a plurality of sequences of chained data records that may be hash-bound to each other grows, so will grow the burden that nodes may experience related to answering queries about having a specific data record. In order to reduce the burden on nodes for answering queries about data records they don't have or do not want to answer questions (i.e., query results), a special data record may be written to the sequence stored by a particular node stating that the node will answer about a specific party's data records. In this regard, the affinity key serves the purpose of registering a data record in a sequence that declares that the node will respond to queries related to a defined company (or other reference) and thereby both reducing traffic to a node and protecting the privacy intended by the creator of the data record.

A signature, for example a digital signature, may be an electronic, encrypted, stamp of authentication on digital information such as email messages, macros, or electronic documents. The signature may authenticate the corresponding data record.

A signer public key may be a public key belonging to a public-private key pair. Each key pair consists of a public key and a corresponding private key. Key pairs are generated with cryptographic algorithms based on mathematical problems termed one-way functions. The signer public key may be used to encrypt a message addressed to the generator of the data record.

A transaction type may be a user defined field, that may indicate the intended use of the data record such as “invoice”, “purchase_order”, “data_proof” or the like. There may be a standard type of transactions or the used-defined types.

A node name may be an IP address of the node that generated the corresponding data record.

A node name may be an alphanumeric random or explicit name, or a domain name for the node that generated the corresponding data record.

Affinity

Affinity between the first and the second data record and/or between the corresponding first and second node may indicate that the first/second party operating the first second/node may be interested and relying upon the data provided by second/first party operating the second/first node being provably free from manipulation. In other words, the affinity between the first and the second data record and/or between the corresponding first and second node may indicate the incentives between the first and second party (i.e., node) to cross-bind its data records to the second and first party (i.e., node). That is an affinity broadcasting will be initially broadcast data to parties with an interest in the data.

The processing circuitry 130 may further be configured to request at least one of the first hash value of a first record or the second hash value of a second record. As described above the processing circuitry 130 may run the first node (or the second node) that is generating the first sequence of chained data records (or the second sequence). Therefore, the processing circuitry 130 may request from the second node that is generating the second sequence (or the first sequence) the second hash code (or the first hash code) between the first data record and the second data record.

However, the decision to request the second hash from the second node (or the first hash from the first node)—instead of for example a further hash from one or more further nodes—may be based on an affinity measure. In other words, the request of the at least one of the first hash value or the second hash value may be based on the affinity measure between the first data record and the second data record.

An affinity measure may measure the affinity between the first and the second data record and/or between the corresponding first and the second node. For example, the affinity measure may display if two companies operating the first and the second node are in a similar industry. For example, an affinity measure may be a string compare between a message data in the first record and the message data in the second record. P2P selection may be based on who is the nearest neighbor of the interested party(s).

Further, the data corresponding to the first data record, the second data record, the third data record or the subsequent data record may be stored in a different storage location than the respective data record. That is, for example the first, second third etc. sequence of chained data records form a data integrity network. The message data in a data record may for example comprise a hash value of a larger data set, for example an image or the like. The larger data set may be stored in the different location like a server or a hard drive or the like.

For example, an identifier for the storage location may be reference by the respective data record. The identifier of the storage location may be referenced by the metainformation, for example as an URL. The storage location may be referred to as secondary or adjacent system (similar to an off-chain platform).

The access to the storage location may be secured by an access control system. An access control system may be a security mechanism designed to regulate who or what can view, use, or access the storage location resource. For example, a username, password, or the like will may be used.

Example of a Data Record

FIG. 4 illustrates an example of a data record 400. The data record 400 may be part of a sequence of chained data records. The data record 400 comprises an epoch. Further, the data record 400 comprises a hash value of a preceding data record (prior_hash) in the sequence of chained data records. The data record 400 comprises a hash value of the current data record 400. All or some of the elements in the data record—beside the current hash value of the data record 400 itself—may be used input to the hash function which is generating the current hash value. For example, the current_hash may be used as sequence or chain ID. Further, the data record 400 comprises one or more hash values of other sequences (of one or more other nodes) that should be chained (hash-bound) to the sequence of the data record 400 (binder(1 . . . N)). The data record 400 may further comprise, a signature, a signer public key, affinity key, a transaction type, a node IP address, and/or a node name.

In the following an example of a data record 400 is given: The message data is: “Hello world”. A hash value of “hello world” using SHA256 cryptographic hash function: 2ef7bde608ce5404e97d5f042f95f89f1c232871

The metainformation may be the type of message data: “string data”. A hash of “string_data”, using a SHA256 cryptographic hash function SHA256: 48c35454f6ac50f0024a55blde0eaa44e569d646

A concatenation of the two hashes separated by a 2ef7bde608ce5404e97d5f042f95f89f1c232871.48c35454f6ac50f0024a55blde0eaa44e569d6 46

A current hash value of the concatenated hash values may be determined using a SHA256 cryptographic hash function: 1957696bb9c9a5f1c86b9781ae9cd7b4455a7a5c

In one example, the hash value of the message data and metainformation may be considered sufficient to establish data integrity. In another example, the hash value of a preceding data record may also be used as input to the hash function generating the current hash value. In another example, all or some of the further elements in the data record may be used as input to the hash function generating the current hash value.

For example, the data record may comprise a field which denotes the scope of hash values derived from the data elements in the data record and may be described as “scope of hash values: “all” or “scope of hashes”: “message and metainformation”.

The data record may be implemented as follows:

{
“epoch”: “123456”,_rec
“prior_hash”:
“eb3b6cfc1a1598d82258e188cbf7be8ec17806c380d30e29c6c25da73b4d17bc”,
“current_hash”: “1957696bb9c9a5f1c86b9781ae9cd7b4455a7a5c“,
“binder”: “db1f2a6e9c9dca4d8b8346256c1e3e5ef8f2a7606c747d1eb8f9d43f8c55ad7c”,
“signature”: “A1B2C3D4E5F6”,
“signer_public_key”: “_AB12_”,
“affinity_key”: “92eb5ffee6ae2fec3ad71c777531578f89a6b09e2e29fbf8d7642d7f6e07376“,
“transaction_type”: “standard”,
“node_ip_address”: “12.12.12.34”,
“node_name”: “intel.com”
}

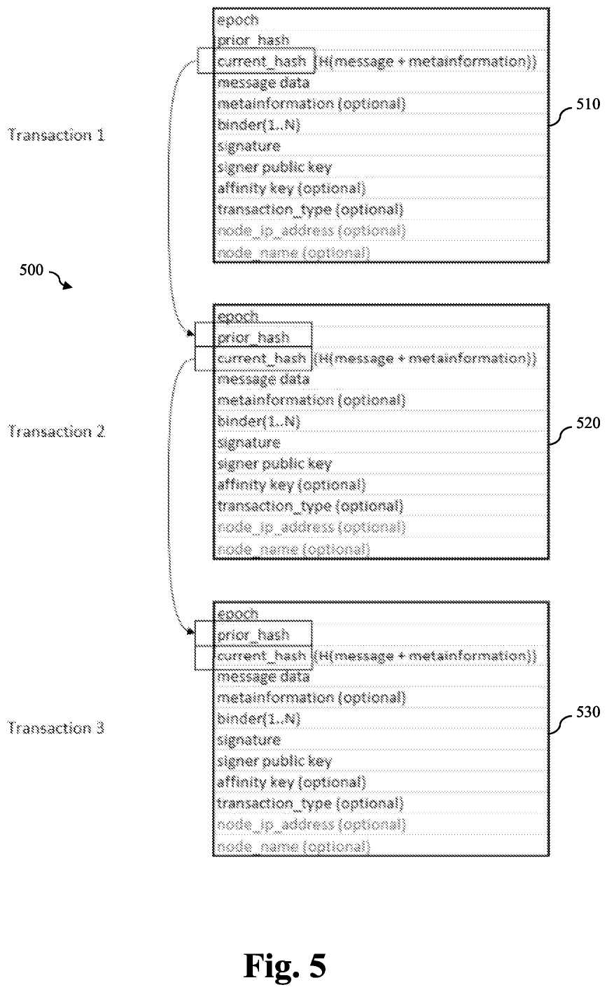

FIG. 5 illustrates a hash binding of data records in a sequence of chained data records 500. The sequence of chained data records comprises a first data record 510 (transaction 1), a second data record 520 (transaction 2) and a third data record 530 (transaction 3). The current hash of the first data record 510 is included in the second data record 520 as prior hash. For example, the current hash of the first data record 510 is an input into the hash function that generates the current hash of the second data record 520. Thereby, the first data record 510 is chained (hash-bound) to the second data record 520. Correspondingly, the current hash of the second data record 520 is included in the third data record 530 as prior hash. For example, the current hash of the second data record 520 is an input into the hash function that generates the current hash of the third data record 530. Thereby, the second data record 520 is chained (hash-bound) to the third data record 530.

Data Verification

The data integrity system as described above may provide a simple means of validating data. A third interested party may interested in the integrity of a sequence of chained data records in the integrity system and may want to validate one of the sequences or a certain data record in a sequence generated by a node. A purpose of data verification may be to establish that some data record or sequence has not been manipulated. This may be reinforced with substantial evidence from known parties, that is the third party may want to validate that sequence generated by the node is sufficiently “tangled” such that the third party can trust the data integrity. Therefore, when the node generates a data record then that data record may be transmitted (pushed) to some other node/requested (pulled) from another node in order to bind that data record into the sequence as described above. Thereby, the integrity of sequence is increased. The third party may then verify a certain data record(s) of a sequence by verifying all the potential hash value cross-bindings in that data record.

For example, after the verification, the operator of the node may communicate to the interested third party (for example through a secondary communication means) information such the reference to the verified data record and the actual data could be correlated.

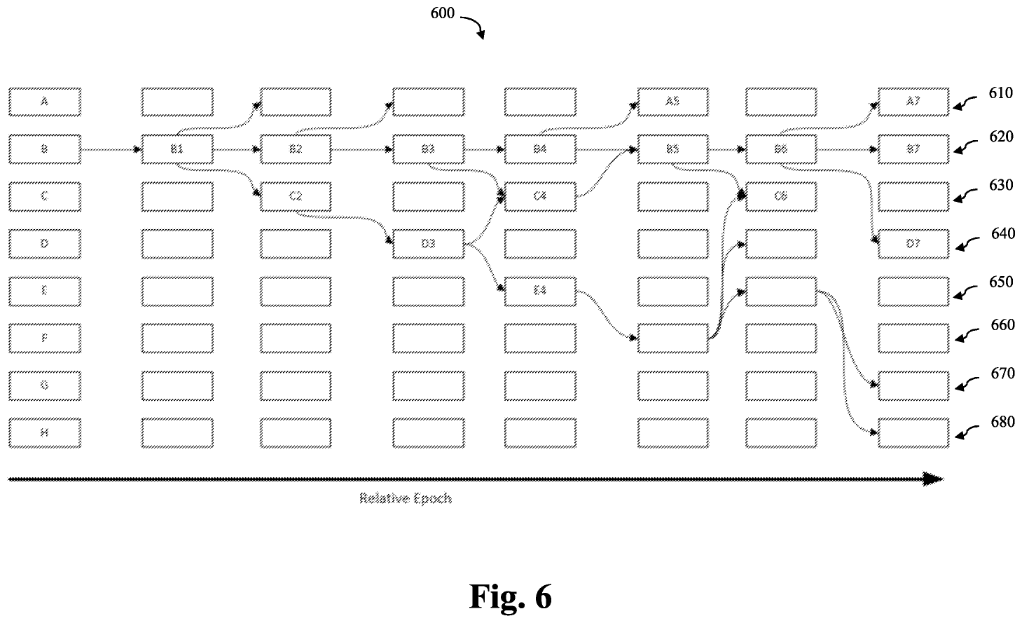

FIG. 6 illustrates an integrity network 600 comprising eight nodes generating sequences of chained data records. The integrity network 600 comprises eight nodes, i.e., nodes A, B, C, D, E, F, G, H. Each node may be run by a different party (for example a company) or some or all nodes may be run by the same party. For example, node B which generates sequence 620 is run by company B. For example, company B shares sequence 620 with a third party, company Z, that is not represented by any of the nodes A-H, may be interested to verify the integrity of a sequence of chained data records 620 generated by node B. For example, the third party may run a copy node and have received the sequence 620 (in another example the third party may also operate a full peer node where they record data and bind it to their data). Nodes A-H may be inspectable by the third party. The third party may want to validate the “chain of evidence” to establish that the sequence is free from manipulation. The third party is for example, starting with verifying data record B7 of sequence 620 and then going back all the other data records of sequence 620. Data record B7 of sequence 620 hash bound to B6 of sequence 620, so B7 may be not that highly trusted yet because it is not yet “well tangled”. Data record B6 of sequence 620 is hash bound to B5 of sequence 620. Data record B6 does not have a binding data record yet that would point back to data record B6. However, the third party may be aware that data record B6 of sequence 620 is hash bound to D7 of sequence 640 and A7 of sequence 610. Node A and node D may provide that information if data record B6 was manipulated. The hash value of data record B5 was further picked up from data record C6 of sequence 630. Further, data record B5 is hash bound it data record B4 (in its home sequence). Data record B5 is further hash-bound to data record C4, which is observed by the third party. The third party then may traverse sequence 630 to sequence 640, etc. for other bindings. At data record B4 of the sequence 620 a reference (binder) to data record A5 of the sequence of chained data records 610 exists. Because B4 has a binder to A5 the third party may inspect data record A5 of the sequence 620. The binder of B4 included in A5 may be verified and if the verification holds then the trust in that sequence 620 and data record B5 are not manipulated increases. Further, data record B3 is hash-bound to data record C4 of sequence 630, data record B2 to sequence 610 and data record B1 to sequence 610 and 630. The nodes which generate sequences to which a data record of the to-be-verified sequence 620 is hash-bound (for example node A that generated sequence 610) may be considered as a trusted source which further increase the trust that no manipulation occurred. It may be established that node A is generated by a trustworthy source because for example a provenance record may be included in the node A's configuration file using DNS-based Authentication of Named Entities (DANE). DANE service is a mechanism that may provide secure authentication and encryption for internet services using the DNS (Domain Name System). DANE may allow domain owners to associate their domain names with cryptographic keys, which may then be used to establish the authenticity and integrity of TLS (Transport Layer Security) certificates used by the domain.

Further, after the third party has identified a cross-certified (cross-binding), for example between data record B5 and data record C4, all that the third party may have, is the hash value of the data record C4 (unless optionally more information is specified in the data record B5). The integrity network 600 may be loosely coupled network influenced by P2P. Therefore, the third party may broadcast to their nearest neighbor node if the neighbor is aware of the questioned hash value (for example the hash value of data record C4) and using known methods for P2P networking a node may respond. New nodes may initialize by creating co-binding data records with one or more other nodes. Various known methods can be employed to propagate information (i.e., data records hash values) across a network or to be discovered as requested. A sequence that is not cross-bound to other party's sequences may not be trusted.

An incentive to maintain a data integrity network is that is very simple, very lightweight and provides a reciprocated benefit.

System of Nodes

FIG. 7 illustrates a system 700 comprising a plurality of nodes. System 700 comprises a first apparatus 102. The first apparatus comprises a first interface circuitry 120 and a first processing circuitry 130. The first processing circuitry 130 is configured to run a first node. The first node is configured to generate a first sequence of chained data records. The first sequence of chained data records comprises a first data record, wherein the first data record comprises a first hash value. Further, the system 700 a second apparatus 102. The second apparatus 102 comprises a second interface circuitry 122 and a second processing circuitry 132. The second processing circuitry 132 is configured to run a second node. The second node is configured to generate a second sequence of chained data records. The second sequence of chained data records comprises a second data record. The second data record comprise a second hash value. In one example, the first processing circuitry (running the first node) 130 is configured to retrieve the second hash value of the second data record from the second node. Or in another example, the second processing circuitry (running the second node) 132 is configured to transmit the second hash value of the second data record to the first node.

In some examples, first processing circuitry 130 is configured to generate a new data record comprising a hash value. The hash value is based on the first hash value of the first sequence of chained data records and on the second hash value of the second sequence chained of data records. Further, the first processing circuitry 130 is configured to add the new data record to the first sequence of chained data records. The new data record following the first data record in the first sequence.

In some examples, the system 700 further comprises a third apparatus 104. The third apparatus 104 comprises a third interface circuitry 124 and a third processing circuitry 134. The third processing circuitry 134 is configured to run a third node. The third node is configured to generate a third sequence of chained data records. The third sequence of chained data records comprises a third data record. The third data record comprises a third hash value. In one example, the first processing circuitry 130 (running the first node) is configured to transmit the generated hash value to the third node. Or in another example, the third processing circuitry 134 is configured to retrieve the generated hash value. The third processing circuitry 134 is configured to generate a further new data record comprising a further hash value, wherein the further hash value is based on the third hash value of the third sequence of chained data records and on the generated hash value of the first sequence chained of data records. Further, the third processing circuitry 134 is configured to add the further new data record to the third sequence of chained data records. The further new data record following the third data record in the third sequence.

The first, the second and the third apparatuses of the system 700, as well as the first, second and third processing circuitries of the system 700 may be configured to carry out the techniques as described above with regards to FIGS. 1-6 and may also comprise the features as described above. Further first, the second and the third apparatuses of the system 700, as well as the first, second and third processing circuitries of the system 700 may be implemented identically to the first, the second and the third apparatuses as well as the first, second and third processing circuitries as described above with regards to FIGS. 1-6.

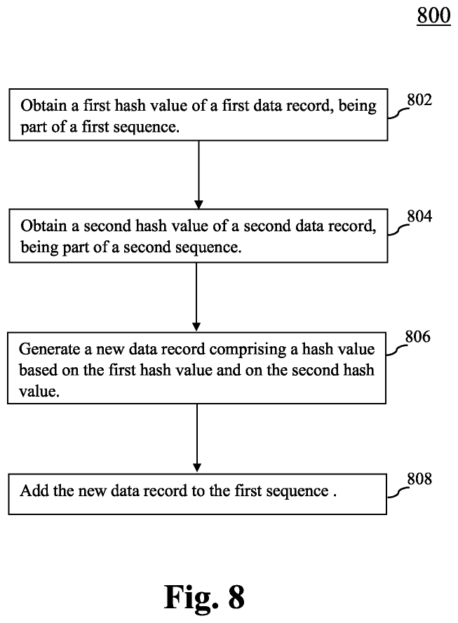

FIG. 8 illustrates a flowchart of an example of a method 800. The method 800 comprises obtaining 802 a first hash value of a first data record. The first data record is part of a first sequence of chained data records. The method 800 comprises obtaining 804 a second hash value of a second data record. The second data record being part of a second sequence of chained data records. The method 800 comprises generating 806 a new data record comprising a hash value. The hash value is based on the first hash value of the first sequence of chained data records and on the second hash value of the second sequence of chained data records. The method 800 comprises adding 808 the new data record to the first sequence of chained data records. The new data record following the first data record in the first sequence.

More details and aspects of the method 800 are explained in connection with the proposed technique or one or more examples described above, e.g., with reference to FIG. 1. The method 800 may comprise one or more additional optional features corresponding to one or more aspects of the proposed technique, or one or more examples described above.

In the following, some examples of the proposed concept are presented:

An example (e.g., example 1) relates to an apparatus comprising interface circuitry, machine-readable instructions, and processing circuitry to execute the machine-readable instructions to obtain a first hash value of a first data record, the first data record being part of a first sequence of chained data records, and obtain a second hash value of a second data record, the second data record being part of a second sequence of chained data records, and generate a new data record comprising a hash value, wherein the hash value is based on the first hash value of the first sequence of chained data records and on the second hash value of the second sequence of chained data records, and add the new data record to the first sequence of chained data records, the new data record following the first data record in the first sequence.

Another example (e.g., example 2) relates to a previous example (e.g., example 1) or to any other example, further comprising that the first hash value is based on a hash value of a data record in the first sequence of chained data records preceding the first data record and/or the second hash value is based on a hash value of a data record in the second sequence of chained data records preceding the second data record.

Another example (e.g., example 3) relates to a previous example (e.g., one of the examples 1 to 2) or to any other example, further comprising that in the first sequence of chained data records and in the second sequence of chained data records a respective following data record is chained to a respective preceding data record based on the following data record comprising a hash value of the preceding data record.

Another example (e.g., example 4) relates to a previous example (e.g., one of the examples 1 to 3) or to any other example, further comprising that the processing circuitry is to execute the machine-readable instructions to obtain a third hash value of a third data record, the third data record being part of a third sequence of chained data records, wherein the third hash value is based on a hash value of a data record in the third sequence of chained data records preceding the third data record, and add the new data record to the first sequence of chained data records, the new data record comprising the hash value, wherein the hash value is further based on the third hash value of the third sequence of chained data records.

Another example (e.g., example 5) relates to a previous example (e.g., one of the examples 1 to 4) or to any other example, further comprising that the processing circuitry is to execute the machine-readable instructions to run a first node, the first node being configured to generate the first sequence of chained data records, and retrieve, by the first node, the second hash value of the second data record from a second node, the second node being configured to generate the second sequence of chained data records.

Another example (e.g., example 6) relates to a previous example (e.g., one of the examples 1 to 4) or to any other example, further comprising that the processing circuitry is to execute the machine-readable instructions to run a first node, the first node being configured to generate the first sequence of chained data records, and transmit, by the first node, the first hash value of the first record or the generated hash value of the new data record to a third node, the third node being configured to generate a fourth sequence of chained data records.

Another example (e.g., example 7) relates to a previous example (e.g., one of the examples 1 to 6) or to any other example, further comprising that the processing circuitry is to execute the machine-readable instructions to generate the hash value of the new data record following the first data record in the first sequence of data records, the new data record comprising the hash value, wherein the hash value of the new data record is further based on at least one of the following an epoch identifier, message data, a hash value of the message data, encrypted message data, metainformation, a hash value of the metainformation, an affinity key, a signature, a signer public key, a transaction type, a node IP address, a node name.

Another example (e.g., example 8) relates to a previous example (e.g., one of the examples 1 to 7) or to any other example, further comprising that the processing circuitry is to execute the machine-readable instructions to request at least one of the first hash value or the second hash value.

Another example (e.g., example 9) relates to a previous example (e.g., example 8) or to any other example, further comprising that the request of the at least one of the first hash value or the second hash value is based on an affinity measure between the first data record and the second data record.

Another example (e.g., example 10) relates to a previous example (e.g., one of the examples 1 to 9) or to any other example, further comprising that at least one of the first hash value, the second hash value, the third hash value or the hash value of the new data record is generated using a cryptographic hash function.

Another example (e.g., example 11) relates to a previous example (e.g., one of the examples 1 to 10) or to any other example, further comprising that at least one of the first data record, the second data record, the third data record or new data record comprise at least one of the following elements an epoch identifier, message data, a hash value of the message data, encrypted message data, metainformation, a hash value of the metainformation, an affinity key, a signature, a signer public key, a transaction type, a node IP address, a node name.

Another example (e.g., example 12) relates to a previous example (e.g., example 11) or to any other example, further comprising that the metainformation comprises a hash value or the metainformation comprises a reference to a storage location of data associated to the data record.

Another example (e.g., example 13) relates to a previous example (e.g., one of the examples 1 to 12) or to any other example, further comprising that data corresponding to the first data record, the second data record, the third data record or the subsequent data record is stored in a different storage location than the respective data record.

Another example (e.g., example 14) relates to a previous example (e.g., example 13) or to any other example, further comprising that an identifier for the storage location is reference by the respective data record.

Another example (e.g., example 15) relates to a previous example (e.g., example 12) or to any other example, further comprising that access to the storage location is secured by an access control system.

Another example (e.g., example 16) relates to a previous example (e.g., one of the examples 1 to 15) or to any other example, further comprising that at least one of the first data record or the second data record are obtained via an application programming interface, API.

An example (e.g., example 17) relates to an apparatus comprising processor circuitry configured to obtain a first hash value of a first data record, the first data record being part of a first sequence of chained data records, and obtain a second hash value of a second data record, the second data record being part of a second sequence of chained data records, and generate a new data record comprising a hash value, wherein the hash value is based on the first hash value of the first sequence of chained data records and on the second hash value of the second sequence of chained data records, and add the new data record to the first sequence of chained data records, the new data record following the first data record in the first sequence.

An example (e.g., example 18) relates to a device comprising means for processing for obtaining a first hash value of a first data record, the first data record being part of a first sequence of chained data records, and obtaining a second hash value of a second data record, the second data record being part of a second sequence of chained data records, and generating a new data record comprising a hash value, wherein the hash value is based on the first hash value of the first sequence of chained data records and on the second hash value of the second sequence of chained data records, and adding the new data record to the first sequence of chained data records, the new data record following the first data record in the first sequence.

An example (e.g., example 19) relates to a method comprising obtaining a first hash value of a first data record, the first data record being part of a first sequence of chained data records, and obtaining a second hash value of a second data record, the second data record being part of a second sequence of chained data records, and generating a new data record comprising a hash value, wherein the hash value is based on the first hash value of the first sequence of chained data records and on the second hash value of the second sequence of chained data records, and adding the new data record to the first sequence of chained data records, the new data record following the first data record in the first sequence.

Another example (e.g., example 20) relates to a previous example (e.g., example 19) or to any other example, further comprising that the first hash value is based on a hash value of a data record in the first sequence of chained data records preceding the first data record and/or the second hash value is based on a hash value of a data record in the second sequence of chained data records preceding the second data record.

Another example (e.g., example 21) relates to a previous example (e.g., one of the examples 19 to 20) or to any other example, further comprising that in the first sequence of chained data records and in the second sequence of chained data records a respective following data record is chained to a respective preceding data record based on the following data record comprising a hash value of the preceding data record.

Another example (e.g., example 22) relates to a previous example (e.g., one of the examples 19 to 21) or to any other example, further comprising that the processing circuitry is to execute the machine-readable instructions to obtain a third hash value of a third data record, the third data record being part of a third sequence of chained data records, wherein the third hash value is based on a hash value of a data record in the third sequence of chained data records preceding the third data record, and add the new data record to the first sequence of chained data records, the new data record comprising the hash value, wherein the hash value is further based on the third hash value of the third sequence of chained data records.

Another example (e.g., example 23) relates to a previous example (e.g., one of the examples 19 to 22) or to any other example, further comprising that the processing circuitry is to execute the machine-readable instructions to run a first node, the first node being configured to generate the first sequence of chained data records, and retrieve, by the first node, the second hash value of the second data record from a second node, the second node being configured to generate the second sequence of chained data records.

Another example (e.g., example 24) relates to a previous example (e.g., one of the examples 19 to 23) or to any other example, further comprising that the processing circuitry is to execute the machine-readable instructions to run a first node, the first node being configured to generate the first sequence of chained data records, and transmit, by the first node, the first hash value of the first record or the generated hash value of the new data record to a third node, the third node being configured to generate a fourth sequence of chained data records.

Another example (e.g., example 25) relates to a previous example (e.g., one of the examples 19 to 23) or to any other example, further comprising that the processing circuitry is to execute the machine-readable instructions to generate the hash value of the new data record following the first data record in the first sequence of data records, the new data record comprising the hash value, wherein the hash value of the new data record is further based on at least one of the following an epoch identifier, message data, a hash value of the message data, encrypted message data, metainformation, a hash value of the metainformation, an affinity key, a signature, a signer public key, a transaction type, a node IP address, a node name.

Another example (e.g., example 26) relates to a previous example (e.g., one of the examples 19 to 25) or to any other example, further comprising that the processing circuitry is to execute the machine-readable instructions to request at least one of the first hash value or the second hash value.

Another example (e.g., example 27) relates to a previous example (e.g., example 26) or to any other example, further comprising that the request of the at least one of the first hash value or the second hash value is based on an affinity measure between the first data record and the second data record.

Another example (e.g., example 28) relates to a previous example (e.g., one of the examples 19 to 27) or to any other example, further comprising that at least one of the first hash value, the second hash value, the third hash value or the hash value of the new data record is generated using a cryptographic hash function.

Another example (e.g., example 29) relates to a previous example (e.g., one of the examples 19 to 28) or to any other example, further comprising that at least one of the first data record, the second data record, the third data record or new data record comprise at least one of the following elements an epoch identifier, message data, a hash value of the message data, encrypted message data, metainformation, a hash value of the metainformation, an affinity key, a signature, a signer public key, a transaction type, a node IP address, a node name.

Another example (e.g., example 30) relates to a previous example (e.g., example 29) or to any other example, further comprising that the metainformation comprises a hash value or the metainformation comprises a reference to a storage location of data associated to the data record.

Another example (e.g., example 31) relates to a previous example (e.g., one of the examples 19 to 30) or to any other example, further comprising that data corresponding to the first data record, the second data record, the third data record or the subsequent data record is stored in a different storage location than the respective data record.

Another example (e.g., example 32) relates to a previous example (e.g., example 31) or to any other example, further comprising that an identifier for the storage location is reference by the respective data record. Another example (e.g., example 33) relates to a previous example (e.g., example 30) or to any other example, further comprising an identifier for the storage location is reference by the respective data record.

Another example (e.g., example 34) relates to a previous example (e.g., one of the examples 19 to 33) or to any other example, further comprising that at least one of the first data record or the second data record are obtained via an application programming interface, API.

Another example (e.g., example 35) relates to a non-transitory machine-readable storage medium including program code, when executed, to cause a machine to perform the method of any one of examples 19 to 35.

Another example (e.g., example 36) relates to a computer program having a program code for performing the method of any one of examples 19 to 35 when the computer program is executed on a computer, a processor, or a programmable hardware component.

Another example (e.g., example 37) relates to a machine-readable storage including machine readable instructions, when executed, to implement a method or realize an apparatus as claimed in any pending claim.

An example (e.g., example 38) relates to a system comprising a first apparatus comprising a first interface circuitry, machine-readable instructions, and a first processing circuitry to execute the machine-readable instructions to run a first node, the first node being configured to generate a first sequence of chained data records, the first sequence of chained data records comprising a first data record, the first data record comprising a first hash value, a second apparatus comprising a second interface circuitry, machine-readable instructions, and a second processing circuitry to execute the machine-readable instructions to run a second node, the second node being configured to generate a second sequence of chained data records, the second sequence of chained data records comprising a second data record, the second data record comprising a second hash value, wherein the first processing circuitry is to execute the machine-readable instructions to retrieve, by the first node, the second hash value of the second data record from the second node, or wherein the second processing circuitry is to execute the machine-readable instructions to transmit, by the second node, the second hash value of the second data record to the first node.

Another example (e.g., example 39) relates to a previous example (e.g., example 38) or to any other example, further comprising that the first processing circuitry is to execute the machine-readable instructions to generate a new data record comprising a hash value, wherein the hash value is based on the first hash value of the first sequence of chained data records and on the second hash value of the second sequence chained of data records, and add the new data record to the first sequence of chained data records, the new data record following the first data record in the first sequence.

Another example (e.g., example 40) relates to a previous example (e.g., example 39) or to any other example, further comprising a third apparatus comprising a third interface circuitry, machine-readable instructions, and a third processing circuitry to execute the machine-readable instructions to run a third node, the third node being configured to generate a third sequence of chained data records, the third sequence of chained data records comprising a third data record, the third data record comprising a third hash value, wherein the first processing circuitry is to execute the machine-readable instructions to transmit, by the first node, the generated hash value to the third node, or wherein the third processing circuitry is to execute the machine-readable instructions to retrieve, by the third node, the generated hash value, and wherein the third processing circuitry is to execute the machine-readable instructions to generate a further new data record comprising a further hash value, wherein the further hash value is based on the third hash value of the third sequence of chained data records and on the generated hash value of the first sequence chained of data records, and add the further new data record to the third sequence of chained data records, the further new data record following the third data record in the third sequence.

Another example (e.g., example 41) relates to a computational system being configured to perform the method any one of examples 19 to 35.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions, and processing circuitry to execute the machine-readable instructions to:
obtain a first hash value of a first data record, the first data record being part of a first sequence of chained data records; and
obtain a second hash value of a second data record, the second data record being part of a second sequence of chained data records; and
generate a new data record comprising a hash value, wherein the hash value is based on the first hash value of the first sequence of chained data records and on the second hash value of the second sequence of chained data records; and
add the new data record to the first sequence of chained data records, the new data record following the first data record in the first sequence.

2. The apparatus according to claim 1, wherein the first hash value is based on a hash value of a data record in the first sequence of chained data records preceding the first data record and/or the second hash value is based on a hash value of a data record in the second sequence of chained data records preceding the second data record.

3. The apparatus according to claim 1, wherein in the first sequence of chained data records and in the second sequence of chained data records a respective following data record is chained to a respective preceding data record based on the following data record comprising a hash value of the preceding data record.

4. The apparatus according to claim 1, wherein the processing circuitry is to execute the machine-readable instructions to:
obtain a third hash value of a third data record, the third data record being part of a third sequence of chained data records, wherein the third hash value is based on a hash value of a data record in the third sequence of chained data records preceding the third data record; and
add the new data record to the first sequence of chained data records, the new data record comprising the hash value, wherein the hash value is further based on the third hash value of the third sequence of chained data records.

5. The apparatus according to claim 1, wherein the processing circuitry is to execute the machine-readable instructions to:
run a first node, the first node being configured to generate the first sequence of chained data records; and
retrieve, by the first node, the second hash value of the second data record from a second node, the second node being configured to generate the second sequence of chained data records.

6. The apparatus according to claim 1, wherein the processing circuitry is to execute the machine-readable instructions to:
run a first node, the first node being configured to generate the first sequence of chained data records; and
transmit, by the first node, the first hash value of the first record or the generated hash value of the new data record to a third node, the third node being configured to generate a fourth sequence of chained data records.

7. The apparatus according to claim 1, wherein the processing circuitry is to execute the machine-readable instructions to generate the hash value of the new data record following the first data record in the first sequence of data records, the new data record comprising the hash value, wherein the hash value of the new data record is further based on at least one of the following: an epoch identifier, message data, a hash value of the message data, encrypted message data, metainformation, a hash value of the metainformation, an affinity key, a signature, a signer public key, a transaction type, a node IP address, a node name.

8. The apparatus according to claim 1, wherein the processing circuitry is to execute the machine-readable instructions to request at least one of the first hash value or the second hash value.

9. The apparatus according to claim 8, wherein the request of the at least one of the first hash value or the second hash value is based on an affinity measure between the first data record and the second data record.

10. The apparatus according to claim 1, wherein at least one of the first hash value, the second hash value, the third hash value or the hash value of the new data record is generated using a cryptographic hash function.

11. The apparatus according to claim 1, wherein at least one of the first data record, the second data record, the third data record or new data record comprise at least one of the following elements: an epoch identifier, message data, a hash value of the message data, encrypted message data, metainformation, a hash value of the metainformation, an affinity key, a signature, a signer public key, a transaction type, a node IP address, a node name.

12. The apparatus according to claim 11, wherein the metainformation comprises a hash value or the metainformation comprises a reference to a storage location of data associated to the data record.

13. The apparatus according to claim 1, wherein data corresponding to the first data record, the second data record, the third data record or the subsequent data record is stored in a different storage location than the respective data record.

14. The apparatus according to claim 13, wherein an identifier for the storage location is reference by the respective data record.

15. The apparatus according to claim 12, wherein access to the storage location is secured by an access control system.

16. The apparatus according to claim 1, wherein at least one of the first data record or the second data record are obtained via an application programming interface, API.

17. A method comprising:
obtaining a first hash value of a first data record, the first data record being part of a first sequence of chained data records; and
obtaining a second hash value of a second data record, the second data record being part of a second sequence of chained data records; and
generating a new data record comprising a hash value, wherein the hash value is based on the first hash value of the first sequence of chained data records and on the second hash value of the second sequence of chained data records; and
adding the new data record to the first sequence of chained data records, the new data record following the first data record in the first sequence.

18. A system comprising:
a first apparatus comprising a first interface circuitry, machine-readable instructions, and a first processing circuitry to execute the machine-readable instructions to:
run a first node, the first node being configured to generate a first sequence of chained data records, the first sequence of chained data records comprising a first data record, the first data record comprising a first hash value;
a second apparatus comprising a second interface circuitry, machine-readable instructions, and a second processing circuitry to execute the machine-readable instructions to:
run a second node, the second node being configured to generate a second sequence of chained data records, the second sequence of chained data records comprising a second data record, the second data record comprising a second hash value;
wherein the first processing circuitry is to execute the machine-readable instructions to retrieve, by the first node, the second hash value of the second data record from the second node; or
wherein the second processing circuitry is to execute the machine-readable instructions to transmit, by the second node, the second hash value of the second data record to the first node.

19. The system according to claim 18, wherein the first processing circuitry is to execute the machine-readable instructions to:
generate a new data record comprising a hash value, wherein the hash value is based on the first hash value of the first sequence of chained data records and on the second hash value of the second sequence chained of data records; and
add the new data record to the first sequence of chained data records, the new data record following the first data record in the first sequence.

20. The system according to claim 19, further comprising:
a third apparatus comprising a third interface circuitry, machine-readable instructions, and a third processing circuitry to execute the machine-readable instructions to:
run a third node, the third node being configured to generate a third sequence of chained data records, the third sequence of chained data records comprising a third data record, the third data record comprising a third hash value;
wherein the first processing circuitry is to execute the machine-readable instructions to transmit, by the first node, the generated hash value to the third node; or
wherein the third processing circuitry is to execute the machine-readable instructions to retrieve, by the third node, the generated hash value; and
wherein the third processing circuitry is to execute the machine-readable instructions to generate a further new data record comprising a further hash value, wherein the further hash value is based on the third hash value of the third sequence of chained data records and on the generated hash value of the first sequence chained of data records; and
add the further new data record to the third sequence of chained data records, the further new data record following the third data record in the third sequence.
